(19) United States
(12) Patent Application Publication
(10) Pub. No.: US 2009/0297280 A1
(43) Pub. Date: Dec. 3, 2009

(54) Shiftable Fluid Diversion Conduit

(76) Inventor: Todd McBride, Chestermere (CA)

Correspondence Address: HESLIN ROTHENBERG FARLEY & MESITI PC, 5 COLUMBIA CIRCLE, ALBANY, NY, 12203, US

(21) Appl. No.: 12/132,889

(22) Filed: Jun. 4, 2008

(30) Foreign Application Priority Data
May 28, 2008 (CA) 2,632,406

(51) Int. Cl. E02D 3/12; G05D 11/00

(52) U.S. Cl. 405/270; 137/115.03

(57) ABSTRACT

A fluid diversion conduit is provided for temporarily diverting a stream during pipeline construction activities. The conduit includes an offset section that is shiftable to adjust access to the streambed, for example to allow pipeline installation across the streambed. When construction activities are obstructed by the initial position of the offset segment, the offset segment may be shifted, for example by rotation to elevate the offset segment from the streambed. Further construction activities may proceed beneath the elevated section, and pipelayers can pass under it while carrying the pipe string into position. Flow through the conduit may be maintained by siphon hydraulics or by pumps when the offset segment is elevated.

### FIELD OF THE INVENTION

The present invention relates generally to stream-crossing construction projects. More particularly, the present invention relates to a conduit for use in diverting stream flow while permitting excavation and construction access to the streambed.

### BACKGROUND OF THE INVENTION

It is often necessary to divert a stream from a section of its natural streambed during various construction projects, such as road, bridge, or buried pipeline-crossing construction. The stream diversion is required to avoid disrupting the stream flow and releasing turbidity into the downstream waters. A typical construction activity that requires this “isolate and bypass” method is the installation of a buried pipeline crossing under the streambed. In order to minimize the environmental disturbance to aquatic life in the stream, the natural water flows must be maintained from one side of the project to the other during construction, and sediments from the construction operation must not be allowed to mix with the flow. It may also be necessary to allow “dry” access to the diverted section of streambed for excavation or other construction activities.

The normal “isolate and bypass” construction practice is to install upstream and downstream cofferdams and divert the flow between the cofferdams through some form of conduit, commonly a channel, hose, flume or conduit. Upon completion of construction, the streambed is appropriately restored and flow is returned to the streambed following removal of the temporary flow bypass system.

Small stream flows are often diverted by use of pumps and hoses or rigid pipelines. However the power requirements for the pumps can be high, the diversion pipeline often impedes pipeline installation, and problematic fine screens are required on the pump inlets to protect the small aquatic species from being harmed in the high speed pump impellers. In winter conditions the fine screens are often blocked by ice and the pipeline must be protected from freezing. Environmental protection measures also require that the pump systems be submersible electric pumps powered by generators located well back from the stream to avoid fuel spills entering the stream. Overall, the pump and pipeline bypassing of larger stream flows is very expensive and cumbersome.

To avoid the need for pumps, long culverts or “flumes”, made of steel pipe are often used. They typically span in a straight line from the upstream cofferdam to the downstream cofferdam. To maximize their capacity they must be installed as low to the streambed as possible. This poses a special problem because a portion of the pipe trench must be excavated under the flume. Backhoes, which are normally used for excavation, cannot easily reach under a low level obstruction and therefore the trench excavation process becomes very time consuming. Once the trench has been excavated, the long prefabricated pipeline “string” would normally be carried across the stream and lowered in by a number of pipelayers (“sidebooms”). However because they usually cannot cross under the flume, the sidebooms can only carry the pipeline to the flume and then have to be disconnected, shuttled to the other side of the flume by passing over a bridge or cofferdam, and then reconnected to the pipe string to continue carrying it into position. Alternately the pipe string can be dragged across the stream and under the flume. However this requires the pipe string to be protected from damage while it is dragged. Often the stream is in a sharp ravine so that dragging the pipe string into position without contacting the flume is not technically possible.

In recent years the level of environmental protection required during construction activities has increased significantly, especially in the pipeline construction industry. Large pipeline projects involving the crossing of hundreds of streams are restricted to using “isolation techniques”, and more convenient stream diversion systems are needed.

A key objective in providing an improved water bypass system is to provide a conduit with adequate hydraulic capacity, while reducing the physical hindrance to excavation and pipe installation or other construction activities.

U.S. Pat. No. 5,947,640 to Connors discloses a flexible tube system for conveying water past a construction site in a streambed. This invention provides an economical and highly portable method of conveying water through a flexible tube. However that tube must be continuously supported, or allowed to lie on the streambed, and the entire length of the tube must be located below the upstream water level to maintain flow.

U.S. Pat. No. 1,984,802 to Mallery discloses another flexible and collapsible tube system for conveying water between two points in a steam so that the “dry” streambed can be accessed for mining and other operations. The tubing may be laterally displaced to allow access to the streambed, however, the flexible and collapsible nature of the tube limits the ability to make these adjustments.

While existing patents cover methods for providing fish passage, and highly portable means for conveying water past streambed construction sites, they do not address the need for conveying high volumes of water across a diversion zone, while allowing for convenient trench excavation or pipe string installation.

### SUMMARY OF THE INVENTION

In a first aspect, there is provided a fluid diversion conduit for conveying fluid past a construction zone, the diversion conduit comprising: an inflow end for receiving fluid to be diverted; an outflow end for discharging diverted fluid, the inflow and outflow ends thereby defining a fluid diversion plane; and an offset conduit segment between and continuous with the inflow and outflow ends, the offset segment shiftable from a first position to a second position with respect to said diversion plane, to facilitate access to the construction zone.

Any portion of the conduit, or the entire conduit, may be composed of rigid tubing, and the inflow and outflow ends are preferably fixed within upstream and downstream cofferdams, respectively.

In an embodiment, the conduit inflow and outflow ends define a rotational axis, and wherein the offset segment is shifted by rotation of the offset segment about the rotational axis. Said rotation may be a 45 degree rotation or greater.

In an embodiment, the offset segment includes a length of bent tubing such that shifting of the offset segment permits access to a ground surface within the construction zone that was previously inaccessible due to obstruction by the offset segment.

In an embodiment, the offset segment comprises a generally V-shaped length of tubing.

In an embodiment, the offset segment comprises a generally U-shaped length of tubing.

In an embodiment, the first position is a substantially horizontal position and wherein the second position is a substantially vertical position, in which the offset segment is elevated from the ground to provide construction access beneath the offset segment.

In an embodiment, the first position is a substantially horizontal position and the second position is another substantially horizontal position.

The conduit may further comprise flow restriction means within the conduit, or operatively associated with the conduit for restricting flow into, through, or out of the conduit.

In an embodiment, the air displacement means are operatively associated with the conduit for eliminating air from the conduit.

In an embodiment, a flexible extension tube is attached to the outflow end of the conduit for limiting air entry into the conduit to maintain siphon conditions.

In an embodiment, a pump is hydraulically connected to the conduit inflow end for pumping fluid through the conduit.

In an embodiment, the conduit further comprises a flexible hose within the conduit and an inlet pump operatively attached thereto that is used to discharge water through the hoses.

In accordance with a second aspect of the invention, there is provided a method for providing ground access for construction activities within a fluid diversion zone, the method comprising the steps of:
providing the fluid diversion conduit in any of the above-described embodiments;
installing the conduit across a diversion zone, the offset segment placed in a first position to provide construction access to a first ground surface within the diversion zone;
conducting construction activities at the first ground surface;
shifting the offset segment of the conduit from the first position to a second position so as to provide access to a second ground surface within the diversion zone; and,
conducting construction activities at the second ground surface.

In an embodiment, the construction activities include excavation of a trench transverse to said diversion plane through the first and second ground surface, and access to the second ground surface is provided by shifting the offset segment to the second position.

In an embodiment, the second position of the offset segment is a position elevated from the first or second ground surface.

In an embodiment, the second position of the offset segment is across the first ground surface.

In an embodiment, the construction activities include pipeline construction.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic view of a stream diversion construction project in accordance with an embodiment of the invention;

FIG. 2 is a schematic view of a stream diversion construction project in accordance with an embodiment of the invention;

FIG. 3a is a top schematic view of a stream diversion in accordance with an embodiment of the invention;

FIG. 3b is a side cross sectional view of a stream diversion in accordance with an embodiment of the invention and,

FIG. 4 is a schematic plan view of a conduit in accordance with an embodiment of the invention.

### DETAILED DESCRIPTION

Generally, the present invention provides a fluid diversion conduit for temporarily diverting fluid flow from a stream or other water body, for example to provide construction access across a streambed for pipeline installation. The fluid diversion conduit includes a shiftable offset segment to allow adjustment of the conduit location across the construction path. A method for providing construction access across the diversion site is also described.

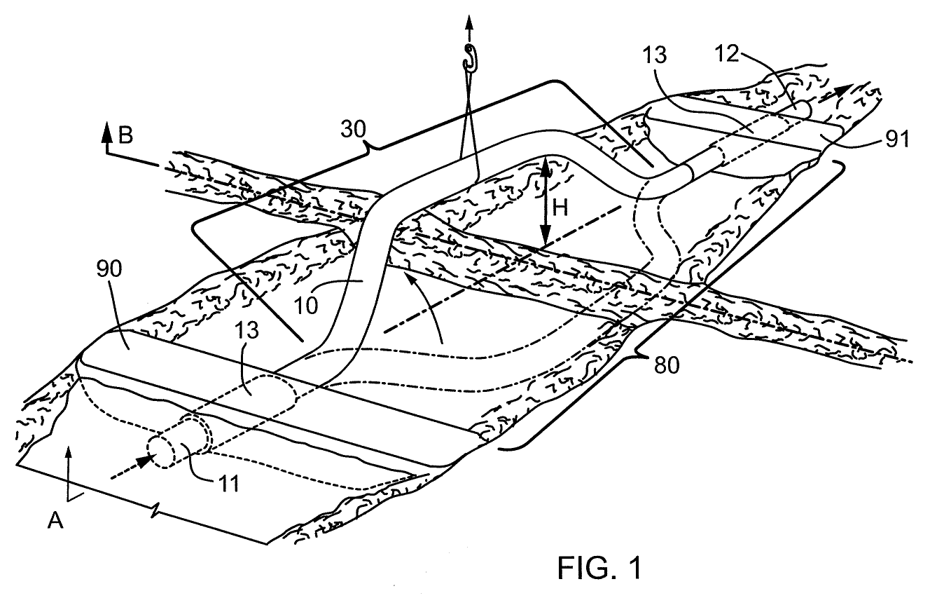

With reference to FIG. 1, an upstream cofferdam 90 is constructed to generate a head of hydraulic pressure upstream of the cofferdam 90, initiating flow through the diversion conduit 10, Stream flow therefore enters conduit 10 at the conduit inflow end 11, is conveyed past the diversion site 80 and through a downstream cofferdam 91, where flow is returned to the natural streambed upon exiting the conduit 10 from outflow end 12.

Once the cofferdams and conduit are in place, excavation and construction may occur across the dry streambed. The inflow end 11 and outflow end 12 of the conduit define a diversion plane A, or general flowpath direction. The offset segment 30 of the conduit is positioned along the length of the conduit so as to align with the intended path of construction activity B across the diversion zone 80.

The offset segment 30 shown in FIG. 1 is rotatable through approximately 180 degrees; from a horizontal position (resting on the ground) on one side of the diversion plane A to the opposing horizontal position. The offset segment may also be fixed in an elevated position at any angle in between these two extremes, for example, in the elevated position shown. In any position of the offset segment, a flowpath may be maintained through the conduit for continuous diversion of fluid. When the offset segment is elevated, flow may be maintained using siphon hydraulics or pumps.

Construction access may therefore be provided along the intended path of construction activity B by simply rotating the position of the offset segment as construction proceeds.

### Conduit

Fluid diversion conduits may vary in shape, size, and material. The term conduit as used herein refers to any passageway used to convey fluid from one location to another. The conduit is preferably of sufficient rigidity to avoid collapse during siphon conditions, as will be described below. The cross-sectional shape, diameter, and length of the conduit may vary.

Large stream bypass conduits used in pipeline construction operations are robustly constructed and are usually fabricated from welded steel pipe. Therefore, the offset segment 30 may also be formed from such pipe for consistency and efficiency. Alternatively, the offset segment may be made of another suitable rigid or somewhat flexible material.

Offset segment 30 allows a portion of the flowpath to be shifted from the general diversion plane A of the conduit as necessary to accommodate construction access along the intended construction path B. The offset segment may be formed by bending a length of steel pipe, or by assembling components of appropriate configuration. To facilitate shifting of the offset segment, the conduit may incorporate sleeves, hinges, flexible portions, or detachment points to allow shifting of the offset segment as construction proceeds. In the embodiment shown in FIG. 1, the portion of the conduit that passes through the cofferdam is coated with a sealing lubricant and wrapped with flexible “slip” membranes 13. The cofferdams are constructed with a granular fill material that seals against the outside of the slip membrane. As the conduit is rotated (for example, using a crane), the sealing lubricant shears but does not allow leakage of fluid past the cofferdam.

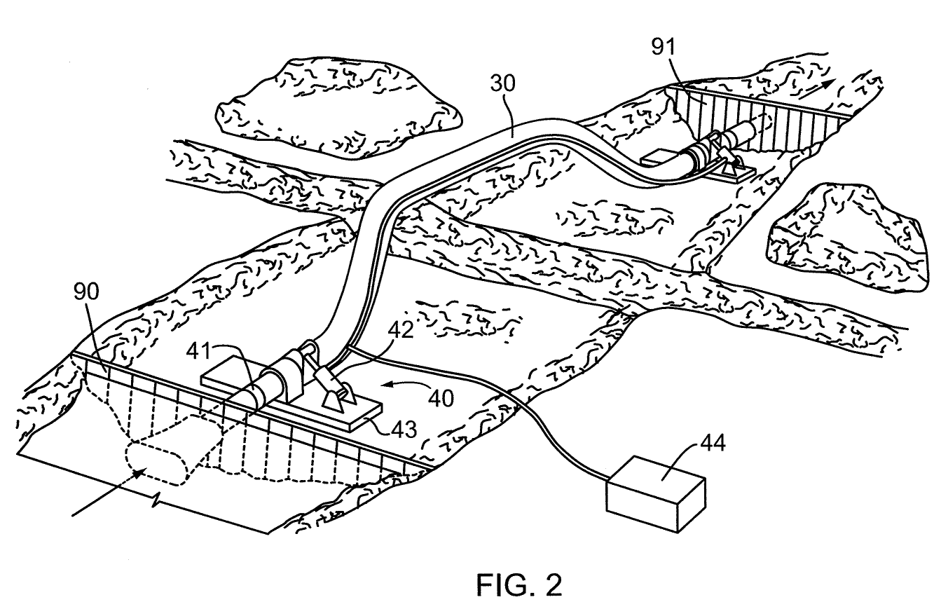

With reference to FIG. 2, an alternate configuration for shifting of the offset segment 30 is shown, in which a hydraulic shifting system 40 rotates the offset segment 30. Rotational seals 41 are placed about the conduit adjacent the offset segment 30, to allow rotation of the offset segment 30 independent of the conduit inflow and outflow ends 11, 12, which are fixed within respective cofferdams 90, 91. Rotational joints and seals on either side of the offset segment 30 allow shifting of the offset segment by the hydraulic shifting system 40, which includes hydraulic cylinders 42, operatively attached to the conduit offset segment 30 and to support bases 43. Actuation of the hydraulic cylinders 41 is monitored and controlled from a hydraulic source 44, to supply and monitor torque and position of the offset segment.

The degree of offset within the conduit should be determined by the size of the conduit, the volume of flow, and the nature of the construction activities required. For example, if flow is minimal and a small diameter conduit is used, a large degree of offset may be possible. When the offset segment is rotated into an elevated position, the vertical offset may be large enough to accommodate passage of pipelayers and other large equipment beneath it during excavation or pipe string installation. Conversely, in large diameter conduits a small degree of offset may be more practical, while still easily accommodating construction activities.

In a minimal offset conduit, rotation of the offset segment into an elevated position may permit a clearance suitable only for trench excavation and pipe manipulation beneath the offset segment when elevated. Alternatively, the offset segment may be rotated from a horizontal position on one side of the diversion plane to the opposing horizontal position to lie over a portion of the completed construction. A smaller offset may be preferred for large conduit diameters because such a bypass conduit would generally be lighter and easier to install and rotate, and would have a higher hydraulic capacity due to reduced bends within the conduit. Further, in narrow streambeds, the offset may be small due to space constraints, unless the degree of rotation is minimized.

### Operation

With reference to FIG. 1, the conduit 10 is installed within a streambed so as to convey water between an upstream cofferdam 90 and a downstream cofferdam 91. The conduit is normally operated with the offset segment in horizontal orientation to permit free flow of fluid therethrough. During shifting of the offset segment, flow may be maintained under siphon conditions, or by pumps associated with the conduit. Alternatively, flow through the conduit may be terminated prior to or during shifting, and reinitiated once shifting is complete.

Once the cofferdams have been constructed and the conduit has been appropriately positioned, the streambed may be pumped dry so as to be accessible to construction activities. For example, a pipeline trench may be excavated along intended path B while offset segment lies horizontal along the ground on the opposing side of the diversion plane A. When construction activities reach the offset segment 30, the offset segment may be temporarily rotated by about 90 degrees into an elevated position such that at the intersection of the diversion plane A and the intended path B, the conduit is elevated to height H. This position, as shown in FIG. 1, provides clearance under the conduit to permit continued excavation, and for installation of the pipe string. Alternately, the conduit can also be rotated a full 180 degrees such that the offset segment lies over the previously excavated portion of the diversion zone, leaving the remaining portion of the intended path B unimpeded. Construction equipment would pass under the offset portion while elevated, or would be transported to the opposite side of the stream to complete the excavation. Thus, normal pipeline construction activities may proceed largely unhindered by stream flow during isolate and bypass stream crossing construction using the conduit 10 with offset segment 30.

When a conduit with large offset is used, construction may occur from either side of the stream, and the conduit is rotated into elevated position as the equipment approaches the diversion plane A. In this manner, construction can be completed quickly, as operations are simultaneously accommodated along the entire length of intended path B.

Overall, the conduit with offset segment allows the use of a high capacity rigid conduit to convey a large water bypass flow without significantly hindering excavation and pipe installation process. It also alleviates the need to monitor and maintain pumping systems, or to monitor a siphon operation, other than for short periods of time.

### Additional Features

Further components and features may be incorporated within the conduit to increase efficiency, improve flow hydraulics, or increase capacity of the conduit. Some examples of these modifications are described below.

### Increased Conduit Capacity

The conduit outflow end 12 may include a hydraulic diffuser segment 20 for recovery of dynamic head from the water flow within the conduit, increasing the hydraulic capacity of the water bypass system beyond what is possible with an identical sized cylindrical conduit (estimated increase of approximately 50%). The increased capacity accommodated by incorporation of a hydraulic diffuser segment 20 within the conduit allows the use of a smaller, less expensive, more easily deployed water bypass conduit for the stream bypass.

Specifically, hydraulic exit loss is minimized within the diffuser segment 20 by slowing fluid flow prior to exit from the conduit. As the cross sectional area of the diffuser segment increases, the fluid flow paths diverge to fill the larger cross-sectional area, thereby reducing the velocity of the water. The dynamic energy lost as flow velocity is converted to a pressure differential across the length of the diffuser segment, effectively reducing the diffuser inlet pressure and increasing the discharge pressure. Since the diffuser section is at the outflow end 12 of the conduit, and the discharge pressure is approximately constant, suction is created within the diffuser, and therefore also along the length of the conduit back to the conduit inflow end 11. This suction serves to pull more water into the inflow end 11 of the conduit 10, thereby increasing the overall hydraulic capacity of the conduit.

### Preventing Air Entry

The conduit will often be operated in shallow streams where the inlet and outlet are not deeply submerged, making air entry into the conduit possible. Significant air volumes in the diffuser section of the conduit would likely result in disruption of streamline flow, ie “boundary layer separation”, and a reduction or loss of the dynamic head recovery, and would impair the ability to maintain siphon conditions within the conduit while the offset segment is in the elevated position.

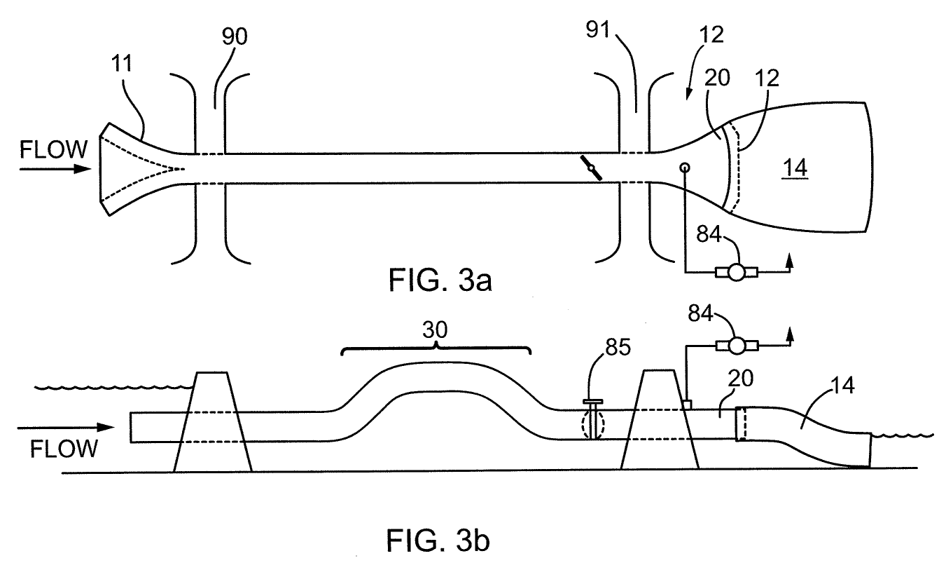

FIGS. 3a and 3b show plan and profile views, respectively, of an embodiment suitable for use with low downstream water levels, including mechanisms for expelling air and for keeping air out of the conduit 10. Conduit inflow end 11 is fully submerged due to appropriate damming, and air entry at the conduit inlet is therefore unlikely. As the downstream water level may fluctuate and at times be lower than the uppermost wall of the diffuser 20 and outflow end 12, air entry may occur, disrupting the laminar streamline flow and suction/siphon effect created within the diffuser segment 20. A flexible extension tube 14 is fitted to the outflow end 12, which is collapsible to the water surface, and is thereby maintained at/under the water surface by the weight and drag of water once flow is initiated. The flexible extension tube 14 therefore prevents air entry into the conduit despite modest variations in the downstream water level. As water flows through the conduit and flexible tube, the tube assumes a shape conforming to the water stream, and the complete inner surface of the tube is in contact with the water stream. This leaves no flow area for air to enter the diffuser in “counter-flow” to the water.

The diffuser 20 may further be designed with a downward curve or downward-facing outlet to ensure the outlet remains beneath the downstream water level. These accommodations will further minimize the risk of air entry into the conduit from the downstream end.

### Expulsion of Air

In addition to prevention of air entry, in certain circumstances (eg. upon initiation of flow), it may be desirable to expel air from the conduit to “prime” the conduit and establish siphon conditions. Therefore, the conduit may include means for extracting air as necessary until appropriate conditions are achieved.

For example, in FIG. 3 a vacuum source or pump 84 is shown, which may be activated to expel air from the conduit in order to achieve streamline flow. Once appropriate flow parameters are achieved, fluid flowing through the diffuser slows in velocity due to the enlarging cross-sectional flow area, and dynamic head is recovered.

As another example, the vacuum source 84 may be replaced with a high capacity steam source (not shown). When necessary, a blast of steam may be forced into the conduit to displace air. As the steam cools and condenses, the conduit is thereby flooded with water, such that air space within the conduit is eliminated.

### Flow Control

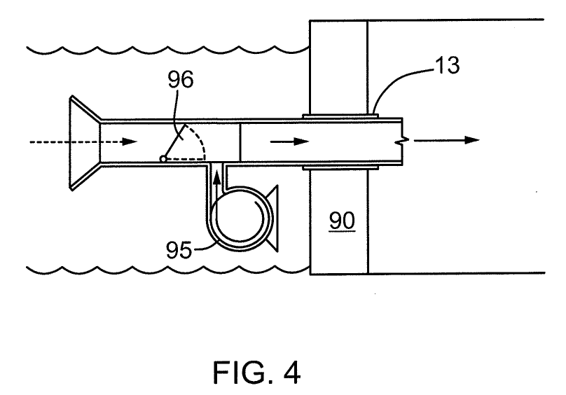

The conduit may further include means for restricting or controlling flow through the conduit. If the hydraulic capacity of the conduit significantly exceeds the stream flow rates, the upstream water level may fall below the conduit inlet, and air may then enter the conduit, interfering with the diffuser hydraulics. One suitable means and location for controlling fluid flow is indicated in FIG. 4 by valve 85 (for example a butterfly valve). This valve 85 may be used to restrict water flow through the conduit to adjust conduit capacity when flow is minimal.

### Siphon Maintenance

When the inflow and outflow ends of the conduit are submerged and no air is able to enter, it will be possible to raise the offset portion of the conduit into an elevated position, while still maintaining siphon flow through the conduit.

Alternatively, if siphon conditions are not attained, or cannot be maintained, a pump may be present at the inflow end of the conduit to force fluid therethrough as necessary, for example while the offset segment is elevated. In some circumstances, it may be acceptable to elevate the offset segment for short periods of time without maintaining flow through the conduit. In such cases, neither pumping nor siphon conditions need to be present.

FIG. 4 shows an example of how a pump may be incorporated to maintain flow when the conduit is rotated if siphon conditions are compromised or nonexistent. The conduit inflow end incorporates a high volume pump 95 upstream of the upstream cofferdam 90. A check valve 96 lies within the conduit and is hydraulically open to the stream. When the pump is not powered, the water enters the conduit through the conduit inflow end 11. When the pump is powered, water enters the conduit through the pump 95 and back-pressure within the conduit closes the check valve 96, so water does not escape back out the otherwise open inflow end 11.

### ALTERNATE EMBODIMENTS

The offset segment configuration shown in the Figures is efficient and simple to fabricate, rotate, and position. However, other configurations are possible depending on the specific diversion situation. It is preferable that the offset segment be bent into a generally U-shaped or V-shaped segment, however, an offset segment containing a single bend may be suitable in some circumstances, with rotation of the conduit providing varying degrees of height along the length of the segment.

Further, the offset segment may include hinged or flexible portions to accommodate dragging of the offset segment along the ground or upon a skid in the streambed to shift its position. In this manner, construction could initially take place up to the offset segment, and the offset segment would then be dragged laterally to cover completed construction and expose the remainder of the construction path B.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. Fluid diversion conduit for conveying fluid past a construction zone, the diversion conduit comprising: an inflow end for receiving fluid to be diverted; an outflow end for discharging diverted fluid, the inflow and outflow ends thereby defining a fluid diversion plane; and an offset conduit segment between and continuous with the inflow and outflow ends, the offset segment shiftable from a first position to a second position with respect to said diversion plane, to facilitate access to the construction zone.

2. The fluid diversion conduit as in claim 1, wherein the offset segment is composed of rigid tubing.

3. The fluid diversion conduit as in claim 1, wherein the inflow and outflow ends are composed of rigid tubing.

4. The fluid diversion conduit as in claim 1, wherein the entire conduit length is composed of rigid tubing.

5. The fluid diversion conduit as in claim 1, wherein the inflow and outflow ends are fixed within upstream and downstream cofferdams, respectively.

6. The fluid diversion conduit as in claim 1, wherein the inflow and outflow ends are rotatably anchored within upstream and downstream cofferdams, respectively.

7. The fluid diversion conduit as in claim 1, wherein the inflow and outflow ends define a rotational axis, and wherein the offset segment is shifted by rotation of the offset segment about the rotational axis.

8. The fluid diversion conduit as in claim 7, wherein the offset segment is rotatable through at least 45 degrees about the rotational axis.

9. The fluid diversion conduit as in claim 1, wherein the offset segment includes a length of bent tubing such that shifting of the offset segment permits access to a ground surface within the construction zone that was previously inaccessible due to obstruction by the offset segment.

10. The fluid diversion conduit as in claim 1, wherein the offset segment comprises a generally V-shaped length of tubing.

11. The fluid diversion conduit as in claim 1, wherein the offset segment comprises a generally U-shaped length of tubing.

12. The fluid diversion conduit as in claim 1, wherein the first position is a substantially horizontal position and wherein the second position is a substantially vertical position, in which the offset segment is elevated from the ground to provide construction access beneath the offset segment.

13. The fluid diversion conduit as in claim 1, wherein the first position is a substantially horizontal position and the second position is another substantially horizontal position.

14. The fluid diversion conduit as in claim 1, further comprising flow restriction means within the conduit.

15. The fluid diversion conduit as in claim 1, further comprising flow restriction means operatively associated with the conduit for restricting flow into, through, or out of the conduit.

16. The fluid diversion conduit as in claim 1, further comprising air displacement means operatively associated with the conduit for eliminating air from the conduit.

17. The fluid diversion conduit as in claim 1, further comprising a flexible extension tube for attachment to the outflow end of the conduit.

18. The fluid diversion conduit as in claim 1, further comprising a pump hydraulically connected to the conduit inflow end for pumping fluid through the conduit.

19. The fluid diversion conduit as in claim 1, further comprising a flexible hose within the conduit and an inlet pump operatively attached thereto that is used to discharge water through the hose.

20. A method for providing ground access for construction activities within a fluid diversion zone, the method comprising the steps of:
providing a fluid diversion conduit for conveying fluid past a construction zone, the diversion conduit comprising: an inflow end for receiving fluid to be diverted; an outflow end for discharging diverted fluid, the inflow and outflow ends thereby defining a fluid diversion plane; and an offset conduit segment between and continuous with the inflow and outflow ends, the offset segment shiftable from a first position to a second position with respect to said diversion plane, to facilitate access to the construction zone;
installing the conduit across a diversion zone, the offset segment placed in a first position to provide construction access to a first ground surface within the diversion zone;
conducting construction activities at the first ground surface;
shifting the offset segment of the conduit from the first position to a second position so as to provide access to a second ground surface within the diversion zone; and,
conducting construction activities at the second ground surface.

21. The method as in claim 20, wherein the construction activities include excavation of a trench transverse to said diversion plane through the first and second ground surface, and wherein access to the second ground surface is provided by shifting the offset segment to the second position.

22. The method as in claim 21, wherein the second position of the offset segment is a position elevated from the first or second ground surface.

23. The method as in claim 21, wherein the second position of the offset segment is across the first ground surface.

24. The method as in claim 20, wherein the construction activities include pipeline construction.
